(19) United States
(12) Patent Application Publication
(10) Pub. No.: US 2018/0111450 A1
(43) Pub. Date: Apr. 26, 2018

(54) L.I.V LEGAL INFORMATION VISORS

(71) Applicants: Kyle Stephen Barringer, TOLEDO, OH (US); William M. Cobb, JR., Jacksonville, FL (US); Florin Poenatiu, Jacksonville, FL (US)

(72) Inventors: Kyle Stephen Barringer, TOLEDO, OH (US); William M. Cobb, JR., Jacksonville, FL (US); Florin Poenatiu, Jacksonville, FL (US)

(21) Appl. No.: 15/400,051

(22) Filed: Jan. 6, 2017

(51) Int. Cl. B60J 3/02; B60R 7/05; B60R 1/00; B60Q 3/252

(52) U.S. Cl. CPC B60J 3/0278; B60Q 3/252; B60R 1/00; B60R 7/05

(57) ABSTRACT

L.I.V is a hard plastic automobile visor fully equipped with built in camera 12 MP, f/1.8, 28 mm, phase detection autofocus, OIS, quad-LED (dual tone) flash video 2160p@30 fps, 1080p@30/60/120 fps, 720p@240 fps, Live feed , Blu-Tooth, 10 in HD Plasma screen , LED LIGHTS , WITH CLEAR HARD PLASTIC ID AND INSURANCE INFO DISPLAY HOLDER.

### SUMMARY OF THE INVENTION 37 CFR 1.73

L.I.V is the future of the American Automobile industry and the potential standard of law enforcement regarding traffic stops. L.I.V Legal information visors are Automobile sun visors that have a camera in them and HD plasma screen in them in place of the mirror to record traffic stops and make legal ID information readily accessible to law enforcement officers.

### DESCRIPTION OF VIEWS OF DRAWINGS 37 CFR 1.74, 1.77(b)9

FIG. 1

Black and white Image of L.I.V legal information visor

FIG. 2

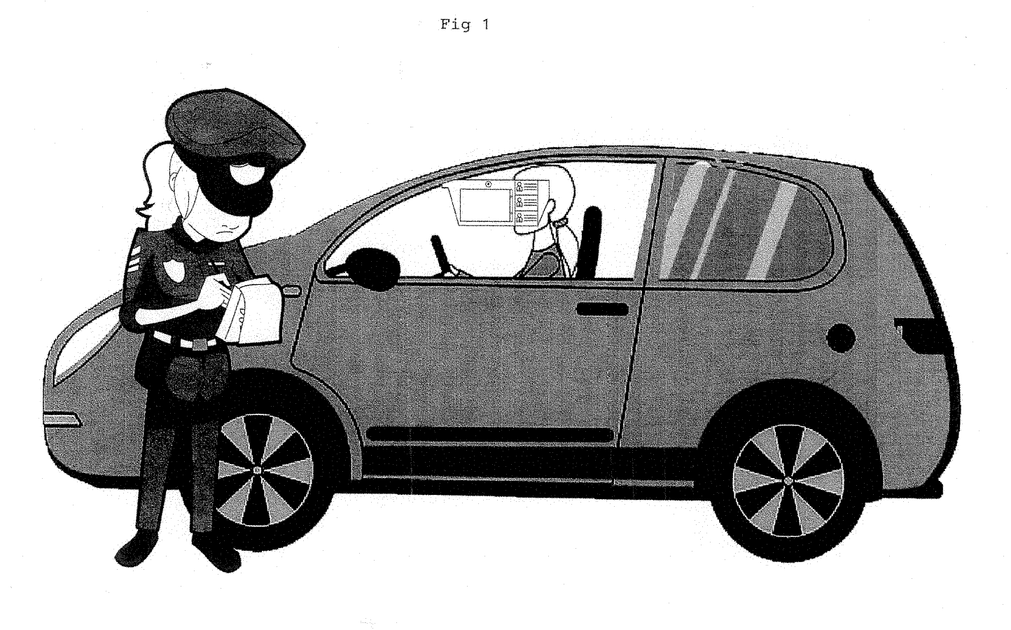

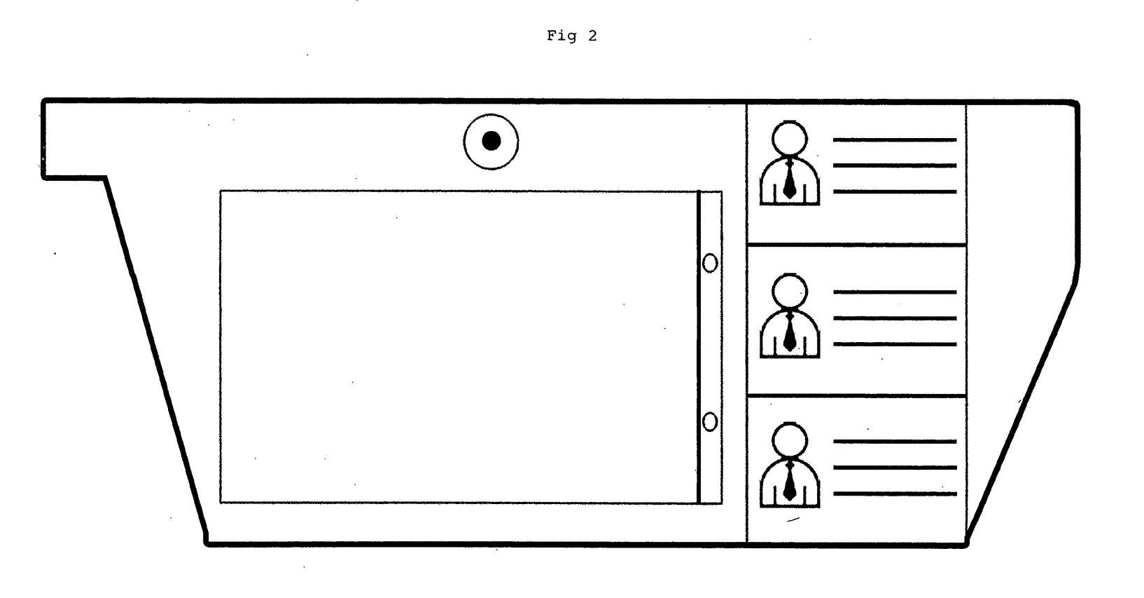

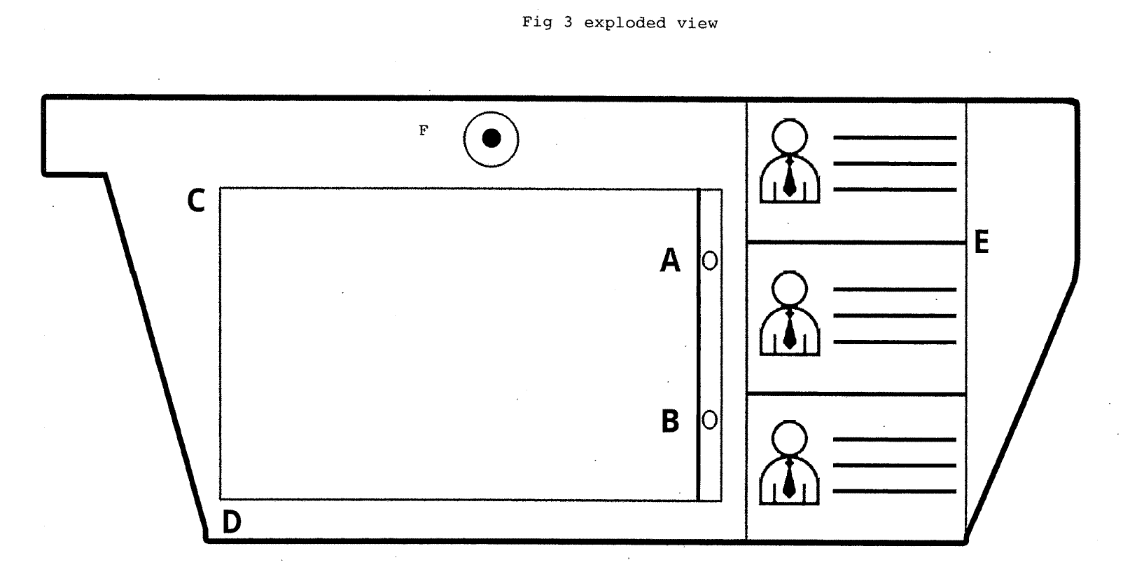

Black and white image of L.I.V in use during routine traffic stop

FIG. 3 Exploded view
A. 1 RED LED LIGHT ON BACK SIDE OF Screen COVER, red signifies a person Driving a motor vehicle in a commercial capacity requiring State issued Drives licensing.
B. 1 GREEN LED LIGHT signifies a person TRAVELING in a PRIVATE conveyance in a non-commercial capacity not requiring the use of any State issued licensing.
C. (IN BRIGHT RED/YELLOW) LEGAL NOTICE OF RESERVATION OF RIGHTS MIRANDA WARNING FOR Public OFFICIAL
D. NOTICE OF AUDIO AND VIDEO SURVEILLANCE.
E. TRANSPARENT ID HOLDER AND FINANCIAL RESPONSIBILITY DOC HOLDER
F. BLUE TOOTH CAPABILITY/ONSTAR CAPABILITY/LIVE FEED Camera

1. I TRUST hereby Independently Claim Full beneficial ownership of the intellectual and physical property/invention known as L.I.V LEGAL INFORMATION VISORS which Is an Automobile Sun visor equipped with built in camera and HD Plasma Screen, LED lights transparent ID and Info holder, with Wi-Fi/Blue tooth/OnStar Live feed capability.
